(19) United States
(12) Patent Application Publication
(10) Pub. No.: US 2026/0231981 A1
(43) Pub. Date: Aug. 13, 2026

(54) FISH ANALOGS

(71) Applicant: GIVAUDAN SA, VERNIER (CH)

(72) Inventors: Laura STIDHAM, Cincinnati, OH (US); Ruben SCAGER, Kemptthal (CH); Madeleine BERNHARDSGRUETTER, Kemptthal (CH); Hannes WENZEL, Kemptthal (CH)

(21) Appl. No.: 19/471,198

(22) PCT Filed: Apr. 19, 2024
(86) PCT No.: PCT/EP2024/060673

§ 371 Date: Sep. 30, 2025

Related U.S. Application Data
(60) Provisional application No. 63/460,966, filed on Apr. 21, 2023.
(60) Provisional application No. 63/546,441, filed on Oct. 30, 2023.

(51) Int. Cl. A23J 3/22; A23J 3/14; A23J 3/20; A23L 27/00; A23L 33/115

(52) U.S. Cl. CPC A23J 3/227; A23J 3/14; A23J 3/20; A23L 27/84; A23L 27/88; A23L 33/115

(57) ABSTRACT

A fish analog product including a single non-animal protein or a mixture of at least two different non-animal derived proteins, a masking agent, a flavorant, an oxidized algae oil and water. A process of preparing a fish analog including the steps of a) mixing pea protein and chickpea protein together; b) adding pea fiber, at least one flavorant and at least one masking agent to a hydration step of the protein mixture, and c) adding an oxidized algae oil.

### TECHNICAL FIELD

The present disclosure relates to fish analog products and methods of making fish analog products.

### BACKGROUND

Most fish analog products contain non-animal protein. One of the challenges of using non-animal protein instead of animal protein is to provide a good “flake type” texture that is perceived as real fish. In other words, the fish analog may comprise fibers or fiber bundles which are aligned in substantially the same direction in order to provide the desired texture of real fish fillet muscle. Additionally, fish analogs prepared according to known processes typically provide an unbalanced flavor and impact due to off-notes from the non-animal proteins. Accordingly, there remains a need for a process for preparing fish analogs having a balanced and authentic flavor profile together with a fish type texture. There also remains a need for a fish analog product with a desired texture that survives canning.

### SUMMARY

In one embodiment, a fish analog product includes a single non-animal protein or a mixture of at least two different non-animal derived proteins, a masking agent, a flavorant, an oxidized algae oil and water.

In another embodiment, a fish analog product includes a mixture of at least two different textured non-animal proteins, a masking agent, a flavorant, an oxidized algae oil and water. The textured non-animal proteins are selected from low moisture and high moisture.

In another embodiment, a process of preparing a fish analog includes the steps of a) mixing pea protein and chickpea protein together; b) adding pea fiber, at least one flavorant and at least one masking agent to a hydration step of the protein mixture, and c) adding an oxidized algae oil.

These and other features, aspects and advantages of specific embodiments will become evident to those skilled in the art from a reading of the present disclosure.

### DETAILED DESCRIPTION

The following text sets forth a broad description of numerous different embodiments of the present disclosure. The description is to be construed as exemplary only and does not describe every possible embodiment since describing every possible embodiment would be impractical, if not impossible. It will be understood that any feature, characteristic, component, composition, ingredient, product, step or methodology described herein can be deleted, combined with or substituted for, in whole or part, any other feature, characteristic, component, composition, ingredient, product, step or methodology described herein. Numerous alternative embodiments could be implemented, using either current technology or technology developed after the filing date of this patent, which would still fall within the scope of the claims.

The present disclosure is based on the surprising discovery that an improved overall flavor and texture can be achieved in fish analog products using the disclosed processes and formulations. In an exemplary embodiment, an improved overall flavor and texture is achieved by blending two or more non-animal proteins (for example pea and chickpea) in combination with flavour and an oxidized algae oil.

A “fish analog” is a food product that approximates the aesthetic qualities and/or chemical characteristics of certain types of fish. The fish analog may be in the form of, for example, a salmon, tuna or white fish fillet. The term fish analog includes those prepared with textured vegetable proteins (TVP), for example, high moisture meat analog (HMMA) and/or low moisture meat analog (LMMA) products. For purposes of this disclosure, vegetable proteins and non-animal proteins are used interchangeably.

Masking or blocking undesirable flavor notes has been practiced in food and beverage development for many years. Historically, this involved using more sugar or fat to cover bitterness and adjust flavor perception. Flavorists simply “over flavored” their products to hide the offending taste. These traditional methods are wholly unsatisfactory, especially for health-conscious consumers where reduced fat and sugar content is a common goal.

Various non-animal derived proteins provide undesirable off-notes. Particularly, undesirable off-notes are the beany, bitter, grassy, astringent, earthy, chalky, and rancid off-notes from pea and soy proteins. The term “off-note” refers to an unpleasant flavour and after taste that develops over time after consumption of consumables. The addition of maskers will block, mask or modify the off-notes and make them less apparent or unnoticeable. Non-animal derived proteins will thereby lose their beany/bitter/grassy/astringent/earthy/chalky/rancid taste.

According to one embodiment, suitable masking agents for use in accordance with the present disclosure include fatty acids including, but not limited to, nonanoic acid, decanoic acid, dodecanoic acid, tetradecanoic acid, hexadecanoic acid, oleic acid, octanoic acid, 9-decenoic and hexanoic.

In another embodiment, suitable masking agents include carbonyls including, but not limited to, acetone, acetyl propionyl, 2-heptanone, 2-nonanone, 2-undecanone and cis-4-heptenal.

In another embodiment, suitable off-note blocking compounds include sulfur, including, but not limited to, isothiocyanates, methyl sulfide, diallyl disulfide, propenyl disulfide, dimethyl sulfide, dimethyl trisulfide and extracts of alliaceous ingredients. In another embodiment, the sulfur components may be found in sulfur containing oils such as, for example, garlic oil, onion oil, mustard oil and horseradish oil.

In another embodiment, suitable masking agents include sweet browns including, but not limited to, maltol, vanillin, cyclopentenolone, furaneol, vanilla extracts, vanilla derivatives, caramel extracts and condensed milk derivatives.

In another embodiment, suitable masking agents include esters including, but not limited to, ethyl cyclohexanoate, ethyl succinate, ethyl lactate, ethyl caprate, ethyl dodecanoate, ethyl myristate, ethyl palmitate and ethyl oleate.

In another embodiment, suitable masking agents include sweeteners including but not limited to, steviol glycosides such as rebaudiosides; rebusodide, swingle extract, mogroside V, erythritol, glucosylated steviol glycosides, honey distillates and sugar distillates.

In another embodiment, suitable masking agents include lactones including, but not limited to, gamma decalactone, delta decalactone, delta dodecalactone, gamma undecalactone and massoia lactone.

In another embodiment, masking agents include juice derivatives including, but not limited to, strawberry, cucumber, apple, cherry, kiwi and apricot.

According to one embodiment, suitable masking agents for use in accordance with the present disclosure include terpenes including, but not limited to, fenchol, terpineol, caryophyllene, bisabolene, farnoscene and farnesol. In another embodiment, suitable terpenes include, but are not limited to, carotenes (such as, for example, alpha-carotene, beta-carotene, gamma-carotene, delta-carotene, lycopene, neurosporene, phytofluene, phytoene), and xanthophylls (such as, for example, canthaxanthin, cryptoxanthin, aeaxanthin, astaxanthin, lutein, rubixanthin); monoterpenes (such as, for example, limonene, perillyl alcohol); sesquiterpenes (such as, for example, caryophyllene, β-caryophyllene, zingiberene); saponins; lipids including: phytosterols, campesterol, beta sitosterol, gamma sitosterol, stigmasterol, tocopherols (vitamin E), and omega-3-6, and -9 fatty acids (such as, for example, gamma-linolenic acid); triterpenoids (such as, for example, oleanolic acid, ursolic acid, betulinic acid, moronic acid); alpha-pinenes, cis-beta-ocimenes and bisabolenes (such as alpha-bisabolene and gamma-bisabolene).

In one example, the fish analog product may include a masking agent in an amount from about 0% to about 2%, in another embodiment from about 0.1% to about 0.5%, or any individual number within the range, by weight of the product.

Disclosed is a process of preparing a fish analog, the process comprising the step of adding at least one first flavorant to a hydration step of non-animal derived protein. By “flavorant” it is meant a composition created by a flavorist using methods known to the skilled person that may be a mixture of tastants, aroma compounds and/or sensates. The flavorant may be a liquid, gel, colloid, or particulate solid, for example, an oil, an extract, an oleoresin, or the like. In certain embodiments, flavorants may include any one or more food-grade flavorants that do not substantially dissolve in water. Examples of flavorants, in particular aromatic or volatile flavorants are for instance essential oils, and other volatile flavorants, like savoury flavorants.

Without limitation, and only by way of illustration, the flavorants may include fish flavor, seafood flavors (including, for example, salmon, tuna, lobster, clam, crab, mussel, scallop, shrimp, oyster), seasonings, spices, herbs, sweet tastants, salty tastants, umami tastants, taste enhancers, taste modifiers, and the like.

Examples of suitable flavorants include natural flavors, natural identical flavors, artificial flavors, spices, seasonings, and the like. Exemplary flavorants include synthetic flavor oils and flavoring aromatics and/or oils, oleoresins, essences, and distillates, and a combination comprising at least one of the foregoing. Generally, any flavorant such as those described in “Chemicals Used in Food Processing”, Publication No 1274, pages 63-258, by the National Academy of Sciences, can be used.

In certain embodiments, at least one first flavorant is added to the hydration step in an amount of about 0.1% to about 10% by weight, or about 0.3% to about 5% by weight, based on the total weight percent of the ingredients. In one example, the fish analog product may include a flavorant in an amount from about 0.3% to about 5%, or any individual number within the range, by weight of the product.

In certain embodiments, water is added in the hydration step in an amount of at least 30% by weight, or at least 40% by weight, or at least 50% by weight, or at least 55% by weight, or at least 60% by weight, or at least 65% by weight, based on the total weight percent of the hydration step ingredients. In one example, the fish analog product may include water in an amount from about 30% to about 65%, or any individual number within the range, by weight of the product.

In certain embodiments, non-animal derived protein is placed in a vessel containing water and then allowed to rest or lightly mixed until the non-animal derived protein is partially or completely hydrated. The non-animal derived protein is hydrated during the hydration step for a period of time ranging from about 10 seconds to 60 minutes.

In certain embodiments, the non-animal derived protein is added in the hydration step in an amount of at least 5% by weight, or at least 10%, or at least 20%, or at least 30% by weight, or at least 40% by weight, based on the total weight percent of the hydration step ingredients. In certain embodiments, the non-animal derived protein is added in the hydration step in an amount of about 20% to about 70% by weight, or about 30% to about 60% by weight, or about 35% to about 55% by weight, based on the total weight of the hydration step ingredients.

In certain embodiments, the ingredients added in the hydration step include water, at least two different non-animal derived proteins, at least one first flavorant, a plant-protein off-taste masking agent, an edible salt, color and an oxidized algae oil. Edible salts include those typically employed in the food and beverage industry and include chlorides, sulphates, phosphates, gluconates, sodium, citrates, carbonates, acetates and lactates. In another embodiment, the flavorant, masking agent, color and oxidized algae oil may be added as a powder, post extrusion. In yet another embodiment, the oxidized algae oil may be added during extrusion in the extruder barrel.

In certain embodiments, “non-animal derived protein” refers to protein preparations made from raw materials including, but not limited to, grain (rice, millet, maize, barley, wheat, oat, sorghum, rye, teff, triticale, amaranth, buckwheat, quinoa); legume or pulses, beans (such as soybean, mung beans, faba beans, lima beans, runner beans, kidney beans, navy beans, pinto beans, azuki beans, and the like), peas (such as green peas, yellow peas, chickpeas, pigeon peas, cowpea, and black-eyed peas and the like), sesame, garbanzo, potatoes, lentils, and lupins; seed and oilseed (black mustard, India mustard, rapeseed, canola, safflower, sunflower seed, flax seed, hemp seed, poppy seed, pumpkin, chia, sesame); nuts (almond, walnut, Brazil, Macadamia, cashews, chestnuts, hazelnuts, pine, pecans, peanuts, pistachio and gingko); algal (kelp, wakame, spirulina, chlorella); mycoprotein and/or fungal protein; insects and leaf protein.

In another embodiment, fish analog products according to the present disclosure include a blend or mixture of at least two different non-animal derived proteins. In another embodiment, the analog may include a blend or mixture of chickpea and pea protein. In another embodiment, the mixture of non-animal derived protein is provided such that the weight ratio of a first non-animal protein to a second non-animal protein is about 3:2. In another embodiment, the mixture of non-animal derived protein is provided such that the weight ratio is about 1:1.

In certain embodiments, the non-animal derived protein is present in an amount of at least 5% by weight, or at least 20% by weight, or at least 30% by weight, or at least 40% by weight, or at least 70% by weight, based on the total weight percent of the fish analog. In certain embodiments, the non-animal derived protein is present in an amount of about 10% to about 50% by weight, based on the total weight of the fish analog. In certain embodiments, the non-animal derived protein is present in an amount of about 20% to about 57% by weight, based on the total weight of the fish analog. In certain embodiments, the non-animal derived protein is present in an amount of about 44% to about 57% by weight, based on the total weight of the fish analog.

In accordance with the present disclosure, the fish analog may also include a vegetable fiber, for example pea fiber. In one example, the fish analog product may include a pea fiber in an amount from about 0.5% to about 15%, in another embodiment from about 1.5% to about 10% or any individual number within the range, by weight of the product.

In accordance with the present disclosure, the fish analog product also includes an oxidized algae oil. In one example, the fish analog product may include oxidized algae oil in an amount from about 0.01% to about 1%, in another embodiment from about 0.1% to about 0.5%, or any individual number within the range, by weight of the product.

In one embodiment, the oxidized algae oil is a liquid. In another embodiment, the oxidized algae oil is a spray dried powder. The spray dried particles may include oxidized algae oil encapsulated in a carbohydrate matrix comprising a film forming carbohydrate, mono, di and trisaccharides and a filler.

Suitable film forming carbohydrates are film forming gums, pectins, alginates, mucilages and mixtures thereof. Preferably the film forming carbohydrates are selected from gum arabic, gum acacia, tragacanth, karaya, ghatti, agar, alginates, carrageenans, fucellan, psyllium and mixtures thereof or from gelatin, dextran, xanthan, curdlan, cellulose, methylcellulose, ethylcellulose, hydroxyethylcellulose, hydroxypropyl cellulose, hydroxypropyl methylcellulose, carboxymethyl cellulose, low methoxy pectin, propylene glycol alginate and mixtures thereof.

Another component of the carbohydrate matrix according to the present disclosure are the mono, di and trisaccharides, which are used in an amount of 10 to 30 wt. %, preferably 15-25 wt. %, based on the total weight of the carbohydrate matrix. Illustrative examples of mono, di and trisaccharides are glucose, fructose, maltose, sucrose, raffinose and materials, having a high content of such sugars like fruit juice solids. Preferably, at least 50 wt. % of the mono, di and trisaccharide material is a disaccharide, as a high amount of monosaccharide may result in a somewhat sticky product whereas a high amount of trisaccharide may lead to a product more prone to oxidation. In one example, the mono, di and trisaccharide material is sucrose.

The carbohydrate matrix according to the present disclosure further includes 10 to 30 wt. %, preferably 10 to 25 wt. % of a filler, for example, maltodextrin. The maltodextrin will, in one embodiment, have a dextrose equivalent (DE) in the range of 1 to 25, and in another embodiment in the range of 10 to 20. A variety of maltodextrins meeting the above requirements are readily available commercially, including maltodextrins from e.g. tapioca, maize and potato.

The particles according to the present disclosure may be produced using standard spray drying equipment and typical conditions known to the art. In another embodiment, particles according to the present disclosure may be produced using multistage dryer (MSD) equipment and typical conditions known in the art. Conditions may naturally vary depending on the nature of the equipment and the material being sprayed, but the person skilled in the art can readily determine the appropriate conditions in every case with only routine experimentation. Typical examples of conditions that produce dry powder with a moisture content of less than 5% and water activity in the desirable range of from 0.05 to 0.30 at 25° C. Water activity (Aw) is the partial vapor pressure of water in a substance divided by the standard state partial vapor pressure of water. It is a measurement of the relative humidity of the sample in a closed chamber-basically Aw is the equilibrium humidity emitted by the sample material.

Typical parameters for use on a conventional tower spray dryer are:
Inlet temperature-100-250° C.
Outlet temperature-60-120° C.

The finished material size should be 10-300 μm mean diameter by volume distribution, as measured by laser diffraction particle size instrument. Other non-limiting examples of suitable drying techniques include fluid bed drying, freeze drying, filtermat and drum drying.

In another embodiment, the fish analog according to the present disclosure further comprises a vegetable oil and/or a vegetable fat. According to certain embodiments, the oils that may constitute the fat component of the composition comprise insect oils, vegetable-derived oils and combinations thereof. According to certain embodiments, the fat component comprises one or more vegetable-derived oils. Without limitation, and only by way of illustration, suitable vegetable oils include almond oil, avocado oil, canola oil, coconut oil, corn oil, cottonseed oil, flaxseed oil, hazelnut oil, illipe oil, linseed oil, palm oil, palm kernel oil, peanut oil, pecan oil, pumpkin seed oil, oat oil, olive oil, rapeseed oil, safflower oil, sesame oil, shea oil, soybean oil, sunflower oil, walnut oil, and mixtures thereof. In certain embodiments, the vegetable oil is present in an amount of at least 1% by weight, or at least 1.5% by weight, based on the total weight percent of the fish analog.

In accordance with the present disclosure, the fish analog product may also include an antioxidant. Suitable anti-oxidants may include vitamin C, vitamin E, rosemary extract, antrancine, butylated hydroxyanisole (BHA), rosemary extract, antracine, and butylated hydroxytoluene (BHT).

The disclosed process may be used to prepare a wide variety of fish analog products, including hybrid fish comprising a plant-originated substance with cultured fish cells or fish substitute products. According to certain embodiments, the fish analog is a vegetarian food product. In other embodiments, the fish analog is a vegan food product containing only plant-derived components and no animal-derived components.

Food scientists have devoted much time developing methods for preparing acceptable fish-like food applications from a wide variety of non-animal proteins. One such approach is texturization into fibrous fish analogs, for example, through extrusion processing. The resulting fish analog products exhibit improved fish-like visual appearance and improved texture.

Texturization of protein is the development of a texture or a structure via a process involving heat, and/or shear and the addition of water. The texture or structure will be formed by protein fibers that will provide a fish-like appearance and perception when consumed. The mechanism of texturization of proteins starts with the hydration and unfolding of a given protein by breaking intramolecular binding forces by heat and/or shear. The unfolded protein molecules are aligned and bound by shear, forming the characteristic fibers of a fish-like product. In one embodiment, polar side chains from amino acids form bonds with linear protein molecules and the bonds will align protein molecules, forming the characteristic fibers of a fish-like product.

To make non-animal proteins palatable, texturization into fibrous fish analogs, for example, through extrusion processing has been an accepted approach. Due to its versatility, high productivity, energy efficiency and low cost, extrusion processing is widely used in the modern food industry. Extrusion processing is a multi-step and multifunctional operation, which leads to mixing, hydration, shear, homogenization, compression, deaeration, pasteurization or sterilization, stream alignment, shaping, expansion and/or fiber formation. Ultimately, the non-animal protein, typically introduced to the extruder in the form of a dry blend, is processed to form a fibrous material.

More recent developments in extrusion technology have focused on using twin screw extruders under high moisture (40-80%) conditions for texturizing non-animal proteins into fibrous fish alternatives. In the high moisture twin screw process, also known as “wet extrusion”, the raw materials, predominantly non-animal proteins are mixed and fed into a twin-screw extruder, where a proper amount of water is dosed in and all ingredients are further blended and then melted by the thermo-mechanical action of the screws. The realignment of large protein molecules, the laminar flow, and the strong tendency of stratification within the extruder's cooling die contribute to the formation of a fibrous structure. The resulting wet-extruded products tend to exhibit improved fish-like visual appearance and improved palatability. Therefore, this extrusion technology shows promise for texturizing non-animal proteins to meet increasing consumer demands for healthy and tasty foods.

Texturization processes may also include spinning, 3D printing, molding, freeze texturization, simple shear flow, and simple shear flow and heat in a Couette Cell (“Couette Cell” technology). The spinning process consists of unfolding protein molecules in a high alkaline pH solution and coagulating the unfolded protein molecules by spraying the protein alkaline solution into an acid bath. The spraying is made by a plate with numerous fine orifices. The protein coagulates forming fibers as soon as it gets in contact with the acid medium. The fibers are then washed to remove remaining acid and/or salts formed in the process. A Couette Cell is a cylinder-based device where the inner cylinder rotates and the outer cylinder is stationary, being easy to scale up. The Couette Cell operates under the same principle of forming protein fibers by subjecting the protein to heat and shear in the space between the stationary cylinder and the rotational cylinder.

With respect to simple shear flow and heat in a Couette Cell, this process can induce fibrous structural patterns to a granular mixture of non-animal proteins at mild process conditions. This process is described in “On the use of the Couette Cell technology for large scale production of textured soy-based meat replacers”, Journal of Food Engineering 169 (2016) 205-213, which is incorporated herein by reference.

In certain compositions, the amount of non-animal protein included in the mixture to be extruded includes no more than about 90% by weight of the dry ingredients. For example, the amount of non-animal protein present in the ingredients utilized to make fish analog products according to the present disclosure may range from about 3% to about 90% by weight of the dry ingredients. In another embodiment, the amount of non-animal protein present in the ingredients utilized to make fish analog products according to the present disclosure may range from about 10% to about 80% by weight of the dry ingredients. In a further embodiment, the amount of non-animal protein present in the dry ingredients utilized to make fish analog products according to the present disclosure may range from about 25% to about 50% by weight. In another further embodiment, the amount of non-animal protein present in the dry ingredients utilized to make fish analog products according to the present disclosure may be about 40%.

The term “dry ingredients” includes all the ingredients in the mixture to be extruded except for added water and ingredients added with the added water (i.e., the “wet ingredients”).

In addition to the foregoing, the fish analog product includes water at a relatively high amount. In one embodiment, the total moisture level of the mixture extruded to make the fish analog product is controlled such that the fish analog product has a moisture content that is at least about 50% by weight. To achieve such a high moisture content, water is typically added to the ingredients. Although, a relatively high moisture content is desirable, it may not be desirable for the fish analog product to have a moisture content much greater than about 65%. As such, in one embodiment the amount of water added to the ingredients and the extrusion process parameters are controlled such that the fish analog product (following extrusion) has a moisture content that is from about 40% to about 65% by weight.

Among the suitable extrusion apparatuses useful in the practice of the described process is a commercially available double barrel, twin-screw extruder apparatus such as a Wenger TX 52 model manufactured by Wenger (Sabetha, Kansas) or Clextral BC21 model manufactured by Clextral (France).

The screws of a twin-screw extruder can rotate within the barrel in the same or opposite directions. Rotation of the screws in the same direction is referred to as single flow or co-rotating whereas rotation of the screws in opposite directions is referred to as double flow or counter-rotating. The speed of the screw or screws of the extruder may vary depending on the particular apparatus; however, it is typically from about 100 to about 750 revolutions per minute (rpm). Generally, as the screw speed increases, the density of the extrudate will decrease. The extrusion apparatus contains screws assembled from shafts and worm segments, as well as mixing lobe and ring-type shearing elements as recommended by the extrusion apparatus manufacturer for extruding non-animal protein material.

The extrusion apparatus generally comprises a plurality of heating zones through which the protein mixture is conveyed under mechanical pressure prior to exiting the extrusion apparatus through an extrusion die. The temperature in each successive heating zone generally exceeds the temperature of the previous heating zone by between about 10° C. to about 70° C. and then the last 1-2 zones are cooled slightly, by 10° C. to about 20° C. before entering the cooling die. The cooling die is set to 40° C. to about 80° C. where the product exits the extruder. In one embodiment, the dry premix is transferred through multiple heating zones within the extrusion apparatus, with the protein mixture heated to a temperature of from about 25° C. to about 160° C. such that the molten extrusion mass enters the extrusion die at a temperature of from about 120° C. In one embodiment, the protein mixture is heated in the respective heating zones to temperatures of about 65° C., about 95° C., about 150° C., and about 160° C.

The pressure within the extruder barrel is typically between about 30 psig and about 500 psig, or more specifically between about 50 psig and about 300 psig. Generally, the pressure within the last two heating zones is between about 50 psig and about 500 psig, even more specifically between about 50 psig to about 300 psig. The barrel pressure is dependent on numerous factors including, for example, the extruder screw configuration, feed rate of the mixture to the barrel, feed rate of water to the barrel, and the viscosity of the molten mass within the barrel.

Water along with additional “wet ingredients” is injected into the extruder barrel to hydrate the non-animal protein mixture and promote texturization of the proteins. As an aid in forming the molten extrusion mass, the water may act as a plasticizing agent. Water may be introduced to the extruder barrel via one or more injection jets. The rate of introduction of water to the barrel is generally controlled to promote production of an extrudate having the aforementioned desired characteristics, such as an extrudate with a moisture content as described above.

Textured vegetable proteins (TVPs) can be defined as food products made from edible protein sources and characterized by having structural integrity and identifiable texture such that each unit will withstand hydration in cooking and other procedures used in preparing the food for consumption. A majority of TVPs produced today are produced by extrusion technology. These TVPs are often rehydrated with 60-65% moisture and blended with other ingredients including, but not limited to, binders, meats, other TVPs, flavors, excipients, fats, oils, or seasonings.

The low-moisture meat analog (LMMA) product is most often cut with an extruder knife at the extruder die to form the finished product size and shape. Drying after extrusion, to remove moisture, improves storage, handling, and shelf-stability. These LMMAs are often rehydrated with 60-70% moisture. Additionally, other food ingredient items can be added to improve finished product functionality and appearance, including, but not limited to, oil, other proteins, salt, seasonings, flavors, maskers, enhancers, or binders. Generally re-hydrated LMMA contains 40-80% moisture, 0-25% oil, and 5-30% protein.

### Examples

The following examples are given solely for the purpose of illustration and are not to be construed as limitations of the present disclosure, as many variations of the invention are possible without departing from the spirit and scope of the present disclosure.

Pea protein (Nutralys® F85M, Roquette, Lestrem, France); Chickpea protein (70C from AGT or JianYuan or Isolates C or B from Nutra or Concentrate C from Nutra); pea fiber (Pea Fiber 150M, Roquette, Lestrem, France); flavorant; masking agent, color, oxidized algae oil and salt were used as ingredients and were blended for 1 to 5 minutes to form the base formulation. Oils such as sunflower, safflower, rapeseed, canola, olive oil and water may be used as ingredients and injected via pumps connected to side injection ports at the barrel of the extruder.

Extrusion was performed using a pilot-scale, co-rotating, intermeshing, twin-screw food extruder to make the HMMA. Continuous dry feeding equipment was used to feed the raw materials into the extruder. While operating, water was injected, via an inlet port, into the extruder by a positive displacement pump.

As seen below, a number of different fish analog products were prepared via extrusion. Table 1 provides ranges of ingredients that cover the examples.

TABLE 1
Fish Analog Compositions

| Ingredients | % |
|---|---|
| Blend of Non-animal Derived Protein (pea + chickpea) | 44-57 |
| Pea Fiber | 2.5-12.5 |
| Salt | 1.0 |
| Masking agent | 0.1-0.3 |
| Flavorant | 0.3-5.0 |
| Color | 0.08-0.6 |
| Algae Oil (oxidized) | 0.1-0.5 |
| Water (Moisture Content) | 44-50 |
| Safflower Oil | 1.5 |

The ingredient % is based on the liquid form. The final RTE dosage would be lower, as water is added after the extrusion. The following blends of non-animal protein were prepared and tested in the above fish analog composition:

### Control (Pea Protein+Pea Fiber)

| Ingredients (%) | Ex. 1 | Ex. 2 | Ex. 3 | Ex. 4 | Ex 5 |
|---|---|---|---|---|---|
| Pea Protein (F85M) | 42.25 | 39.75 | 37.25 | 34.75 | 32.25 |
| Pea Fiber (I50M) | 2.5 | 5 | 7.5 | 10 | 12.5 |

### Fish Analog Blends (Pea Protein+Chickpea Protein+Pea Fiber)

| Ingredients (%) | Ex. 6 | Ex. 7 | Ex. 8 | Ex. 9 | Ex. 10 |
|---|---|---|---|---|---|
| Chickpea Protein (70C) | 0 | 10 | 20 | 30 | 40 |
| Pea Protein (F85M) | 42.33 | 33.33 | 24.33 | 15.33 | 6.33 |
| Pea Fiber (I50M) | 5 | 4 | 3 | 2 | 1 |

| Ingredients (%) | Ex. 11 | Ex. 12 |
|---|---|---|
| Chickpea Protein | 19 | 28.5 |
| Pea Protein (F85M) | 25.3 | 16.8 |
| Pea Fiber (I50M) | 3 | 2 |

### High Moisture Textured Vegetable Protein (“HMTVP”) Canned Tuna Method

Canned Tuna

### Method

1. Defrost the HMMA overnight in the fridge at 4° C.
2. Steam the HMMA for 10 minutes at 98° C.
3. Remove the HMMA from the bag and cut lengthwise.
4. Cut the halved strips to pieces 1-3 cm long. The length of this cut will determine the longest fibers you will find in the final product.
5. Shred the material using a food processor for 3-4 minutes until properly shredded.
6. Weigh the product into the bowl of the vacuum tumbler and 30% of the HMMA weight water e.g. 70 grams of HMMA+30 grams of water to make 100 grams of product or use the formula below.

$$Add water to reach = \frac{Weight of shredded T VP}{0.7}$$

For example, for 500 grams of shredded HMMA add water until the total weight in the vessel is 500/0.7=714 grams
8. Close the vacuum tumbler and place under a vacuum of 40mBar, place on the machine and tumble for 10 minutes.
9. Fill the cans with ~120 grams of material, lightly compressing to place the lid on top without material poking out of the sides.
10. Close the cans using the closing machine.
11. Retort the cans for 20 minutes at 121 degrees.

Table 2 below exemplifies a blend of low moisture and high moisture TVP according to the present disclosure.

TABLE 2
Fish Analog Compositions

| Ingredients | % |
|---|---|
| Non-animal derived low moisture LMMA | 2.5-20 |
| Non-animal derived high moisture HMMA | 2.5-20 |
| Salt | 1.0 |
| Masking agent | 0.01-0.5 |
| Flavorant | 0.3-5.0 |
| Non-animal derived protein source or blend | 0.5-5 |
| Color | 0.08-0.6 |
| Algae Oil (oxidized) | 0.1-0.5 |
| Water (Moisture Content) | 44-50 |
| Safflower Oil | 1-25 |

Non-animal derived high and/or low moisture TVP can be produced with various single sources (e.g. soy, pea, chickpea, potato) or blends of non-animal derived proteins following the ranges given in Table 2. For the preparation of the canned product, the following procedure was used.
1. Defrost the high moisture HMMA overnight in the fridge at 4° C.
2. Hydrate low moisture LMMA with respective amount of water, flavor and masker 3. Shred defrosted high moisture HMMA in Thermomix food processor at speed 5 for 12 seconds, scratch bowl and repeat.
5. Shred hydrated low moisture LMMA accordingly for 15 seconds.
6. Form an emulsion using the non-animal derived protein source by blending water as well as the remaining flavors, maskers and oils.
7. Combine all phases in an Hobart mixer and blend at low rpm for 2 min.
8. Fill the cans with ~120 grams of material, lightly compressing to place the lid on top without material poking out of the sides.
9. Close the cans using the closing machine.
10. Retort the cans with an F0 of min 5.

It should be understood that when a range of values is described in the present disclosure, it is intended that any and every value within the range, including the end points, is to be considered as having been disclosed. For example, “a range of from 50 to 100” of a component is to be read as indicating each and every possible number along the continuum between 50 and 100. It is to be understood that the inventors appreciate and understand that any and all values within the range are to be considered to have been specified, and that the inventors have possession of the entire range and all the values within the range.

In the present disclosure, the term “about” used in connection with a value is inclusive of the stated value and has the meaning dictated by the context. For example, it includes at least the degree of error associated with the measurement of the particular value. One of ordinary skill in the art would understand the term “about” is used herein to mean that an amount of “about” of a recited value produces the desired degree of effectiveness in the compositions and/or methods of the present disclosure. One of ordinary skill in the art would further understand that the metes and bounds of “about” with respect to the value of a percentage, amount or quantity of any component in an embodiment can be determined by varying the value, determining the effectiveness of the compositions for each value, and determining the range of values that produce compositions with the desired degree of effectiveness in accordance with the present disclosure. The term “about” is further used to reflect the possibility that a composition may contain trace components of other materials that do not alter the effectiveness or safety of the composition.

As used in this specification, the terms “comprises,” “comprising,” “contains,” “containing,” “includes,” “including,” “has,” or “having,” are all open-ended expressions and are intended to cover apparatus, compositions, methods, processes, products, or systems that comprise a recited list of components, elements, and features, and any and all additional components, elements and features that are not expressly recited. The terms “includes,” “including,” “has,” or “having” are not intended to have a more narrow construction, interpretation, or meaning than the terms “comprises” or “comprising.”

As used in the present specification, the term “or” refers to an inclusive “or” and not to an exclusive “or”. For example, the phrase “A or B” is satisfied by any one of the following: A is present and B is not present, A is not present and B is present, and both A and B are present.

As used in the present specification, “a” or “an” is employed to describe components, elements, features and method/process steps of various illustrative embodiments disclosed herein.

The use of “a” or “an” should be interpreted to include one or more than one.

As used in the present specification, any of the terms “illustratively,” “preferably,” “commonly,” and “typically” are not intended to, and do not, limit the scope of the claimed embodiments, or to imply that certain features are critical, essential, important, or required to the structure or function of the claimed processes and resulting meat analog products. Rather, these terms are merely intended to identify particular aspects of an embodiment or to emphasize alternative or additional features that may or may not be utilized in a particular embodiment.

1. A fish analog product comprising a single non-animal protein or a mixture of at least two different non-animal derived proteins, a masking agent, a flavorant, an oxidized algae oil and water.

2. The fish analog product according to claim 1, wherein the non-animal protein is selected from the group consisting of grain; legume; pulses; seed; oilseed; nut; algal; mycoprotein; fungal protein; insects; leaf protein; and combinations thereof.

3. The fish analog product according to claim 2, wherein the non-animal protein is selected from the group consisting of rice; millet; maize; barley; wheat; oat; sorghum; rye; teff; triticale; amaranth; buckwheat; quinoa; soybean; sesame; mung beans; chickpeas; garbanzo; peas; fava beans; lentils; lima beans; lupins; peanuts; pigeon peas; runner beans; kidney beans; navy beans; pinto beans; azuki beans; cowpea; black-eyed peas; black mustard; India mustard; rapeseed; canola; safflower; sunflower seed; flax seed; hemp seed; poppy seed; pumpkin; chia; sesame; almond; walnut; Brazil; Macadamia; cashews; chestnuts; hazelnuts; pine; pecans; pistachio; gingko; kelp; wakame; spirulina; chlorella; and combinations thereof.

4. The fish analog product according to claim 1, wherein the non-animal derived protein is a mixture of pea and chickpea.

5. The fish analog product according to claim 4, wherein the weight ratio of pea to chickpea is about 3:2.

6. The fish analog product according to claim 1 further comprising pea fiber.

7. The fish analog product according to claim 1, wherein the oxidized algae oil is present in an amount for from about 0.01% to about 1% of the product.

8. The fish analog product according to claim 7, wherein the oxidized algae oil is present in an amount fer from about 0.1% to about 0.5% of the product.

9. A fish analog product comprising a mixture of at least two different textured non-animal proteins, a masking agent, a flavorant, an oxidized algae oil and water, wherein the textured non-animal proteins are selected from low moisture and high moisture.

10. The fish analog product according to claim 9, wherein the low moisture non-animal protein is present in an amount from 2.5% to 20% of the product.

11. The fish analog product according to claim 9, wherein the high moisture non-animal protein is present in an amount from 2.5% to 20% of the product.

12. The fish analog product according to claim 9, wherein the low moisture non-animal protein comprises a single non-animal protein or a mixture of at least two different non-animal derived proteins.

13. The fish analog product according to claim 9, wherein the high moisture non-animal protein comprises a single non-animal protein or a mixture of at least two different non-animal derived proteins.

14. The fish analog product according to claim 9, wherein the non-animal protein is selected from the group consisting of grain; legume; pulses; seed; oilseed; nut; algal; mycoprotein; fungal protein; insects; leaf protein; and combinations thereof.

15. The fish analog product according to claim 9, wherein the oxidized algae oil is present in an amount for from about 0.1% to about 0.5% of the product.

16. A process of preparing a fish analog product, the process comprising the steps of:
a) mixing pea protein and chickpea protein together;
b) adding pea fiber, at least one flavorant and a masking agent to a hydration step of the protein mixture, and
c) adding an oxidized algae oil.
